(19) United States
(12) Patent Application Publication
(10) Pub. No.: US 2026/0240697 A1
(43) Pub. Date: Aug. 20, 2026

(54) ADJUSTABLE HIGH CHAIR

(71) Applicant: ORMESA S.R.L., Foligno (PG) (IT)

(72) Inventor: Luigi MENICHINI, Foligno (PG) (IT)

(21) Appl. No.: 19/161,396

(22) PCT Filed: Feb. 26, 2024
(86) PCT No.: PCT/IB2024/051814

§ 371 Date: Sep. 2, 2025

(30) Foreign Application Priority Data
Mar. 3, 2023 (IT) 102023000003930

(51) Int. Cl. A61G 5/10

(52) U.S. Cl. CPC A61G 5/1059

(57) ABSTRACT

A seating unit that includes a linkage mechanism adapted to move the seating unit between closed, extended, reclined, and seat-lift positions is provided. The linkage mechanism includes a footrest assembly and a back-mounting link coupled to a seat-mounting plate, a base plate coupled to a lift-base assembly via a lift assembly, a drive bracket, a motor tube, and two linear actuators for automating adjustment of the linkage mechanism. In operation, a first phase involves a second linear actuator rotating the motor tube, thereby causing the seat-adjustment assembly to bias the seat-mounting plate. A second phase involves a first linear actuator rotating the drive bracket, thereby causing the footrest assembly to extend or retract without affecting the bias of the back-WO mounting link. A third phase involves the first linear actuator causing the lift assembly to raise and tilt the base plate directly over the lift-base assembly.

The present invention relates to an adjustable high chair, particularly for individuals with motor impairment.

As it is known, individuals who are not able to maintain a sitting posture independently due to varying degrees of motor impairment generally make use of an aid that is commonly defined as “adjustable high chair” and is designed to provide a sitting, functional, and restraining position that can be varied by the caregivers depending on the activity being performed or proposed by the caregiver.

An adjustable high chair allows the patient to maintain a sitting posture for a variety of activities, such as eating, playing, learning, communicating, entertaining, and resting. Each one of these activities requires a specific posture of the patient and thus a specific configuration of the high chair.

Since the high chair is used both at home and in educational institutions (rehabilitation centers, schools, etc.), such a high chair must have a small size.

Generally, an adjustable high chair comprises a base, a seat, a backrest and a lifting system arranged between the base and the seat to raise and adjust the seat at a certain height in accordance with the daily use of the high chair.

Lifting systems comprising pneumatic-type linear actuators arranged in a vertical configuration are known. Obviously, such types of lifting systems allow for a limited travel given by the length of the cylinder and of the piston of the actuator. In addition, if the cylinder of the actuator is very long, even in a space-saving configuration with the seat fully lowered, such a high chair still will still occupy a large vertical space that is given by the length of the cylinder of the actuator. Therefore, such high chairs do not have a space-saving configuration for storage purposes in which the seat is arranged on the base.

Lifting systems comprising a lever mechanism, generally of compass type, driven by spring and/or gas actuators are known. However, such a type of lever mechanism raises the seat both vertically and posteriorly—and not only vertically. Otherwise said, the seat is moved backward when it is raised, and is moved forward when it is lowered. As a result, when the patient is sitting in the high chair, the center of gravity of the high chair is moved backward when the seat is raised and is moved forward when the seat is lowered. Obviously, to prevent the high chair from tipping backward during lifting or forward during lowering, the base of the high chair must be long enough to contain a vertical projection of the center of gravity of the high chair, even when the seat is at its highest or lowest height.

Such a problem is more pronounced in the case of high chairs with a tilting seat and a tilting backrest. In fact, a tilting of the seat and/or of the backrest would shift the center of gravity of the patient sitting in the high chair forward or backward, requiring an increase in the size of the base. In the case where the size of the base of the high chair is not to be increased, obviously the possible tilting of the seat and of the backrest will be severely limited by the size of the base.

Thus, such an adjustable high chair with lever lifting system according to the prior art is greatly impaired by the excessive size of the base caused by the displacement of the center of gravity of the high chair when raising and lowering the seat. As a result, the high chair with lever lifting system according to the prior art has the following drawbacks due to its excessively large base:
difficulties in moving the high chair when it is used with the patient,
hindrance of the high chair for third parties moving in the space in which the high chair is disposed,
difficulties in maintaining a constant distance between patient and caregiver for assistance during therapeutic proposals and/or functional activities, and
difficulties in transporting and storing the high chair when it is not used by the patient.

WO2013/103809A2 describes a linkage mechanism for a dual-motor lifting recliner.

US2018/360217A1 describes a dual motor lift chair for the elderly. U.S. Pat/ No. 6,000,758A describes a reclining lift chair provided with a reversible D.C. motor.

The purpose of the present invention is to eliminate the drawbacks of the prior art by providing an adjustable high chair that is versatile, provides a wide range of adjustment, allows the caregiver to stay close to the patient when adjusting the height, and at the same time occupies a minimum space in length.

Another purpose is to provide such a high chair that can be arranged in a space-saving configuration for storage.

Another purpose is to provide such a high chair that is reliable and easy to use.

These purposes are achieved in accordance with the invention with the features of the appended independent claim 1.

Advantageous achievements of the invention appear from the dependent claims.

Further features of the invention will appear clearer from the following detailed description, which refers to a purely illustrative and therefore non-limiting embodiment, illustrated in the appended drawings, wherein:

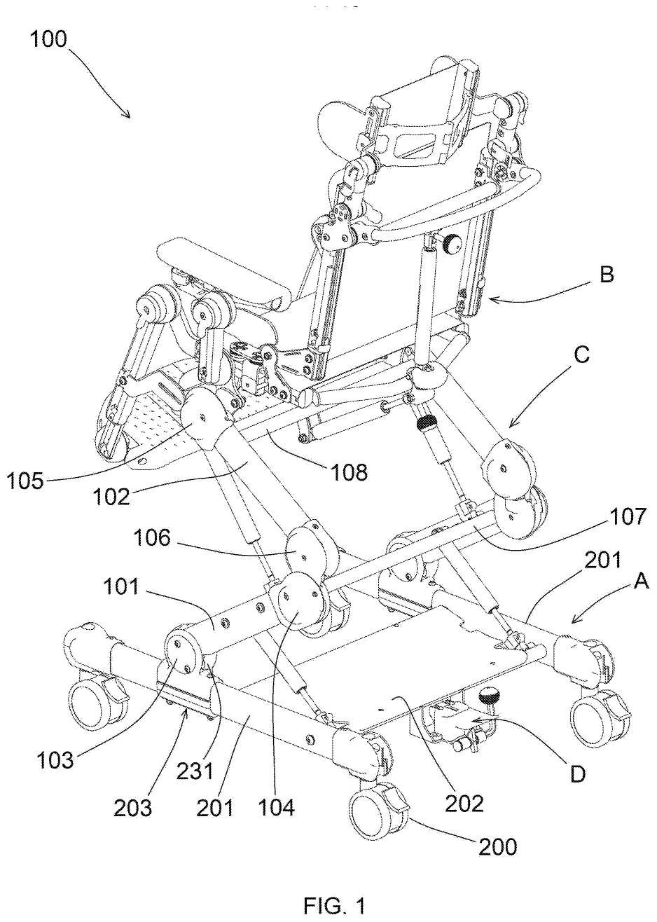

FIG. 1 is a perspective view of the high chair according to the invention;

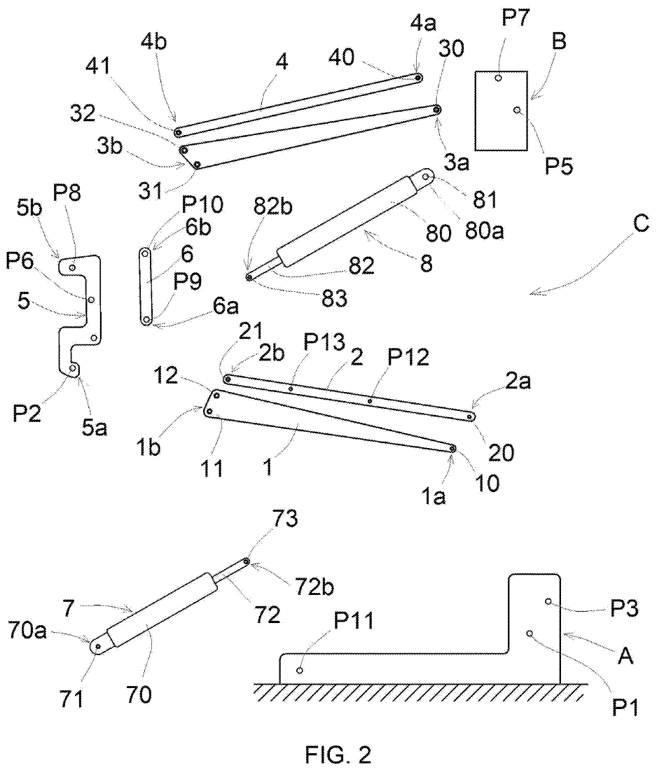

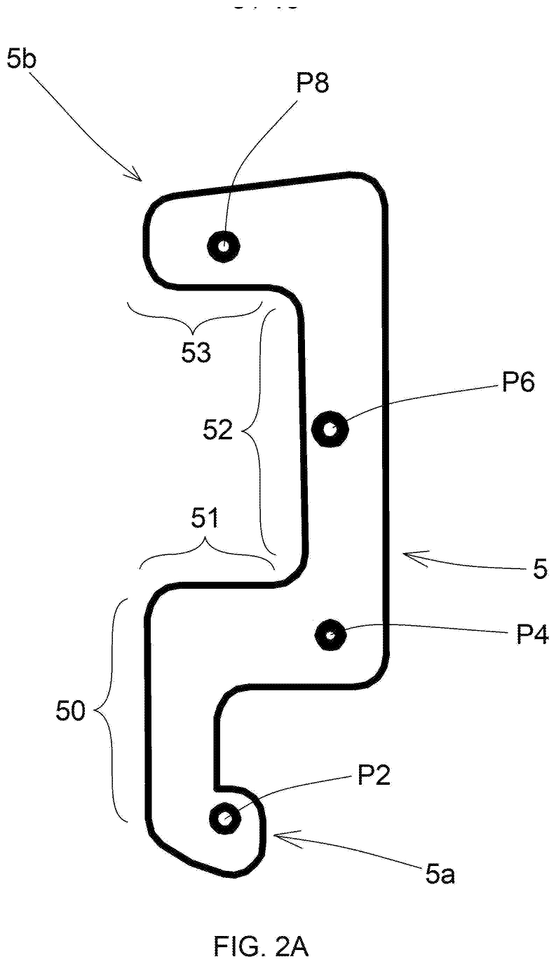

FIG. 2 is an exploded diagrammatic side view of the lifting system of the high chair;

FIG. 2A is an enlarged detail of FIG. 2 illustrating a first connecting rod of the lifting system;

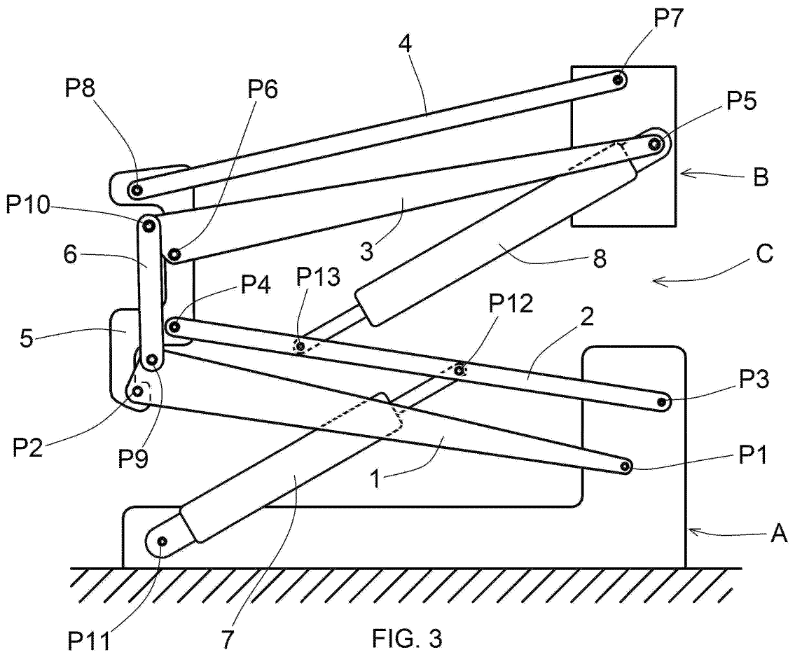

FIG. 3 is a diagrammatic side view of the lifting system in lowered position;

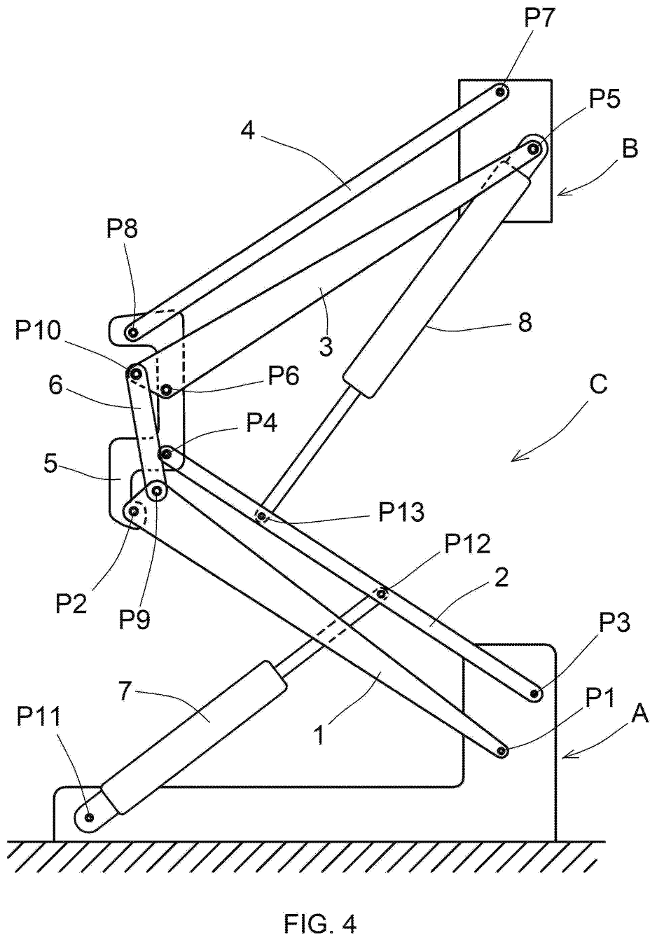

FIG. 4 is a diagrammatic side view of the lifting system in raised position;

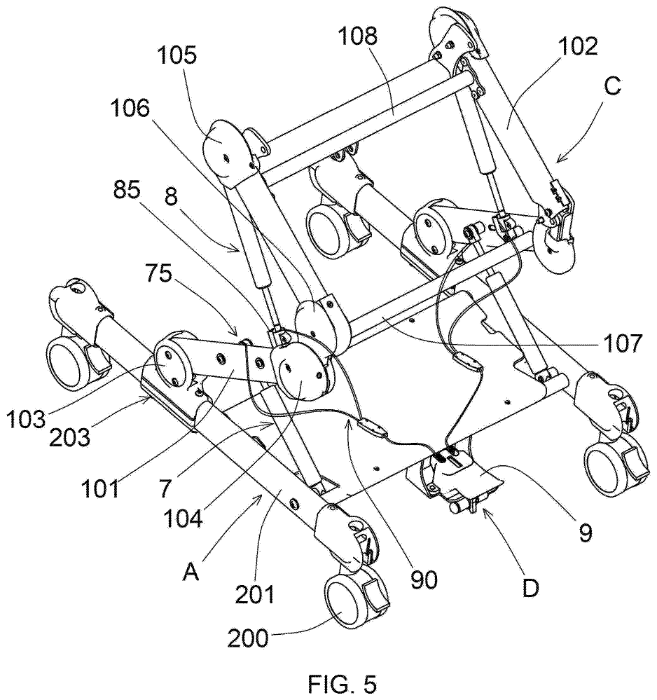

FIG. 5 is a perspective rear view, illustrating only the base and the lifting system of the body of the high chair, with the actuating means of the actuators of the lifting system;

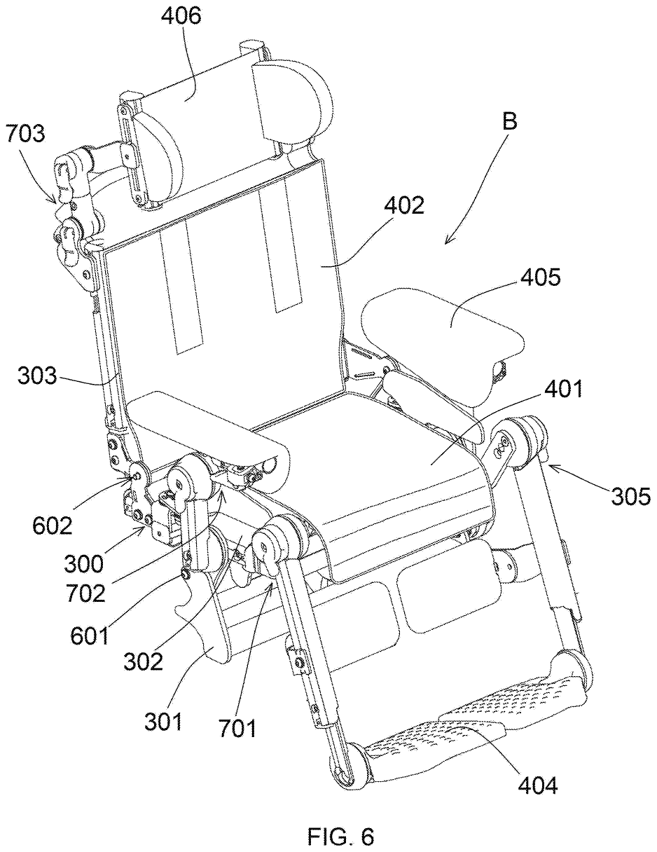

FIG. 6 is a front perspective view of the body of the high chair;

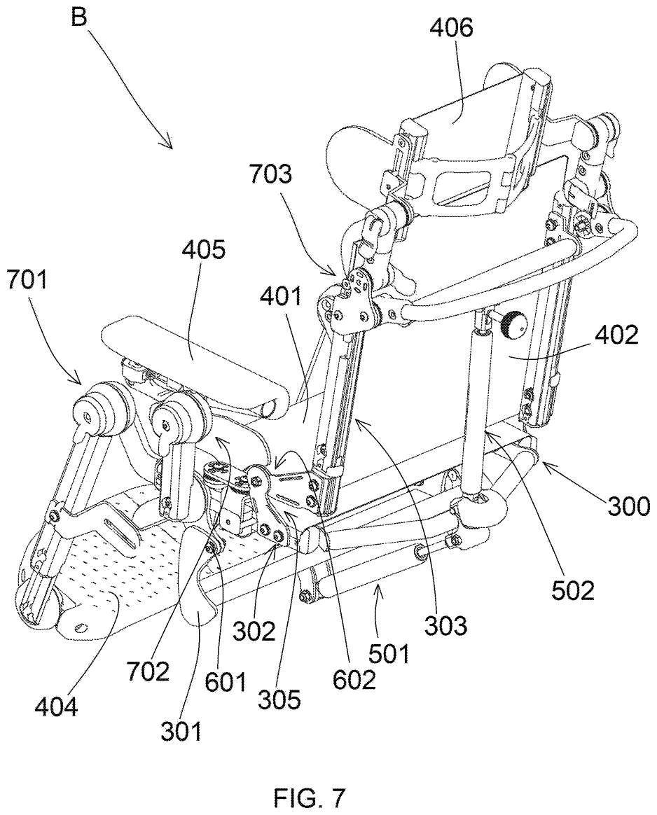

FIG. 7 is a perspective rear view of the body of the high chair;

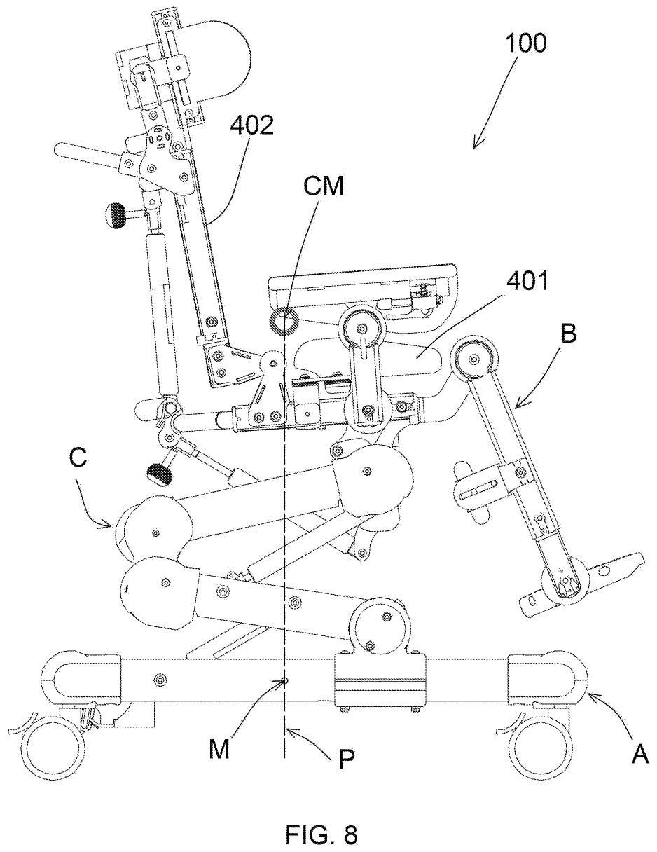

FIG. 8 is a side view of the high chair in lowered position; and

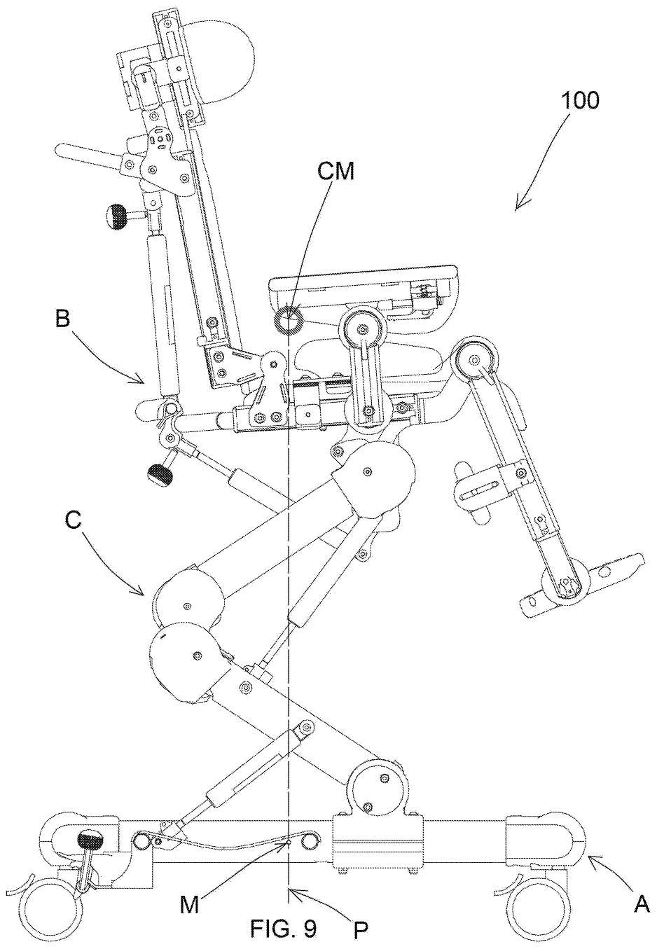

FIG. 9 is a side view of the high chair in raised position.

With reference to the Figures, the high chair according to the invention is described, which is generally denoted by reference numeral 100.

Now with reference to FIG. 1, the high chair (100) comprises a base (A), a body (B) and a lifting system (C) arranged between the base (A) and the body (B) to raise the body (B) relative to the base (A) in an adjustable manner.

Referring to FIG. 2, the lifting system (C) is a lever type system with levers operated by actuators. The lifting system (C) comprises:
a first lower lever (1) and a second lower lever (2) pivoted to the base (A),
a first upper lever (3) and a second upper lever (4) pivoted to the body (B),
a first connecting rod (5) pivoted to the first lower lever (1), to the second lower lever (2), to the first upper lever (3) and to the second upper lever (4),
a second connecting rod (6) pivoted to the first lower lever (1) and to the first upper lever (3),
a first actuator (7) pivoted to the base (A) and to the second lower lever to allow for a movement of the assembly comprising said first lower lever (1) and said second lower lever (2) relative to the base (A), and
a second actuator (8) pivoted to the body (B) and to the second lower lever (2) to allow for a compass-type movement of the assembly comprising the first upper lever (3) and the second upper lever (4) with respect to the assembly comprising the first lower lever (1) and the second lower lever (2).

With reference to FIGS. 3 and 4, such a lifting system (C) allows the body (B) to be raised and lowered in a perfectly vertical direction, without moving the body (B) forward or backward during its raising and lowering. Furthermore, such a lifting system (C) allows the high chair (100) to be configured in a space-saving configuration, in which the angle between the base (A) and the first lower lever (1) is about 10° and the angle between the second lower lever (2) and the first upper lever (3) is about 20°.

Returning to FIG. 2, the first lower lever (1) has a first end (1a) and a second end (1b) that is longer than the first end. The first end (1a) of the first lower lever has a hole (10) that is pivoted to the base (A) by means of a first pin (P1). The second end (1b) of the first lower lever has a hole (11) that is pivoted to a lower end (5a) of the first connecting rod (5) by means of a second pin (P2).

The second lower lever (2) has a first end (2a) with a hole (20) that is pivoted to the base (A) by means of a third pin (P3). The third pin (P3) is above the first pin (P1). The second lower lever (2) has a second end (2b) with a hole (21) that is pivoted to the first connecting rod (5) above the second pin (P2) by means of a fourth pin (P4). In this way, the first lower lever (1) and the second lower lever (2) are substantially parallel to each other (see FIGS. 3 and 4).

The first upper lever (3) has a first end (3a) and a second end (3b) that is larger than the first end. The first end (3a) of the first upper lever has a hole (30) that is pivoted to the body (B) by means of a fifth pin (P5). The second end (3b) of the first upper lever has a hole (31) that is pivoted to the first connecting rod (5) above the fourth pin (P4) by means of a sixth pin (P6).

The second upper lever (4) has a first end (4a) with a hole (40) that is pivoted to the body (B) by means of a seventh pin (P7). The seventh pin (P7) is above the fifth pin (P5). The second upper lever (4) has a second end (4b) with a hole (41) that is pivoted to an upper end of the first connecting rod (5) by means of an eighth pin (P8). In this way, the first upper lever (3) and the second upper lever (4) are substantially parallel to each other (see FIGS. 3 and 4).

The first lower lever (1) has a second hole (12) at the second end (1b) that is pivoted to a lower end (6a) of the second connecting rod (6) by means of a ninth pin (P9). The first upper lever (3) has a second hole (32) at the second end (3b) that is pivoted to an upper end (6b) of the second connecting rod (6) by means of a tenth pin (P10). In this way, the second connecting rod (6) is maintained substantially parallel to the first connecting rod (5) and both connecting rods are maintained in a substantially vertical alignment.

It should be noted that the second connecting rod (6) is a straight rod. In contrast, the first connecting rod (5) is square-wave shaped. Referring to FIG. 2A, starting from its lower end (5a), the first connecting rod (5) comprises a first vertical section (50) that continues with a first horizontal section (51) that continues with a second vertical section (52) that continues with a second horizontal section (53) ending in the upper end (5b). The first pin (P2) is located near the lower end (5a), the fourth pin (P4) is located in a connecting portion between the first horizontal section (51) and the second vertical section (52). The sixth pin (P6) is located at an intermediate position of the second vertical section (52), and the eighth pin (P8) is located near the upper end (5b) of the first connecting rod.

Going back to FIG. 2, the first actuator (7) and the second actuator (8) are linear actuators comprising a sliding piston in a cylinder.

The first actuator (7) has a cylinder (70) having an end (70a) with a hole (71) pivoted to the base (A) by means of an eleventh pin (P11) anteriorly to the first pin (P1). The first actuator (7) has a piston (72) having an end (72b) with a hole (73) pivoted to the second lower lever (2) by means of a twelfth pin (P12).

The second actuator (8) has a cylinder (80) having an end (80a) with a hole (81) pivoted to the body (B) by means of the fifth pin (P5). Otherwise said, the cylinder (80) of the second actuator is pivoted to the body (B) in the same pin in which the first upper lever (3) is also pivoted. The second actuator (8) has a piston (82) having an end (82b) with a hole (83) pivoted to the second lower lever (2) by means of a thirteenth pin (P13). The thirteenth pin (P13) is arranged anteriorly to the twelfth pin (P13).

With reference to FIGS. 3 and 4, it should be noted that, in the second lower lever (2), the distance between the third pin (P3) and the twelfth pin (P12) is substantially equal to the distance between the twelfth pin (P12) and the thirteenth pin (P13) and substantially equal to the distance between the thirteenth pin (P13) and the fourth pin (P4).

Referring to FIG. 5, the high chair (100) comprises actuating means (D) connected to the first actuator (7) and to the second actuator (8) in order to operate said actuators (7, 8). The actuating means are arranged in a position accessible to a user (caregiver) of the high chair.

By way of example, the actuating means (D) may comprise a pedal (9) arranged in a rear part of the base (A) and connections (90) connecting the pedal (9) to the actuators (7, 8).

Advantageously, the actuators (7, 8) are of the pneumatic type and comprise respective normally closed valves (75, 85) that lock the actuators in position. When the user operates the actuating means (D), the valves (75, 85) of the actuators open and the first actuator (7) raises the assembly comprising the first lower lever (1) and the second lower lever (2) with respect to the base (A); on the other hand, the second actuator (8) raises the assembly comprising the first upper lever (3) and the second upper lever (4) with respect to the assembly comprising the first lower lever (1) and the second lower lever (2) so as to raise the body (B) with respect to the base (A).

In order to lower the body (B) relative to the base (A), the user operates the actuating means (D) and pushes the body (B) down to overcome the force of the actuators (7, 8). Upon reaching the desired position of the body, the user releases the actuating means and the lifting system (C) is locked in place.

With reference to FIGS. 1 and 5, the high chair (100) comprises:
a lower tube (101) that corresponds to the second lower lever (2) and contains the first lower lever (1), and
an upper tube (102) that corresponds to the second upper lever (4) and contains the first upper lever (3).

A first lower shell (103) and a second lower shell (104) are arranged at the ends of the lower tube (101).

A first upper shell (105) and a second upper shell (106) are arranged at the ends of the upper tube (102).

The first lower shell (103) covers the pins (P1, P3) used to hinge the first lower lever and the second lower lever to the base (A).

The second lower shell (104) covers the pins (P2, P4) used to hinge the first lower lever and the second lower lever to the first connecting rod (5). The first upper shell (105) covers the pins (P5, P7) used to hinge the first upper lever and the second upper lever to the body (B).

The second upper shell (106) covers the pins (P6, P8) used to hinge the first upper lever and the second upper lever to the first connecting rod (5).

The high chair (100) comprises two lifting systems (C) mounted on the sides of the high chair. In such a case, the two lifting systems (C) are connected by a first crosspiece (107) and by a second crosspiece (108). The first crosspiece (107) connects the first two tubes (101) near the second lower shells (104). The second crosspiece (108) connects the two second tubes (102) near the first upper shells (105).

The base (A) is supported on swivel wheels (200). The base (A) has an essentially H-shape. The base (A) comprises two beams (201) and a crossbar (202) that joins the two beams (201). The crossbar (202) may consist of a plate that serves as a support surface.

The base (A) comprises a support (203) that corresponds to the first lower shell (103) mounted on the beam (201) to support the lifting system (C). The pins (P1, P3) hinge the first lower lever and the second lower lever to the support (203) attached to the beam.

Referring to FIGS. 6 and 7, the body (B) comprises a frame (300) having a first portion (301) connected to the lifting means (C).

The frame (300) comprises a second portion (302) supporting a seat (401). The second portion (302) of the frame is hinged to the first portion (301) of the frame by a first hinge (601). First adjustment means (501) are interposed between the first portion (301) of the frame and the second portion (302) to adjust a tilt of the seat (401) relative to a horizontal plane. The first adjustment means (501) can be a cylinder-piston actuator of spring or pneumatic type.

The frame (300) comprises a third portion (303) that supports a backrest (402). The third portion (303) of the frame is hinged to the second portion (302) of the frame by a second hinge (602) to tilt the backrest relative to the seat, that is, to tilt the backrest relative to a vertical plane. Second adjustment means (502) are interposed between the second portion (302) of the frame and the third portion (303) of the frame to adjust a tilt of the backrest (402) relative to the seat (401). The second adjustment means (502) can be a cylinder-piston actuator of spring or pneumatic type.

The second portion (302) of the frame of the body is connected to a first hinged linkage (701) that supports footrests (404) arranged under the seat (401) so that the footrests (404) can be moved according to the patient's needs. The second portion (302) of the frame of the body is also connected to a second hinged linkage (702) that supports armrests (405) arranged on either side of the seat (401), so that the armrests (405) can be moved according to the patient's needs.

The third portion (303) of the frame of the body is connected to a third hinged linkage (703) that supports a headrest (406) arranged above the backrest (402), so that the headrest (406) can be moved according to the patient's needs.

With reference to FIGS. 8 and 9, the center of gravity of the high chair (100) is denoted by CM, in the case where the seat (401) lies on a horizontal plane and the backrest (402) lies on a substantially vertical plane. The projection of the center of gravity on a horizontal plane is denoted by P. With reference to FIG. 8, when the body (B) is lowered, the projection (P) of the center of gravity (CM) passes through a midpoint (M) of the base (A); therefore, the high chair (100) is perfectly stable.

With reference to FIG. 9, when the body (B) is raised, the projection (P) of the center of gravity (CM) still passes through the midpoint (M) of the base (A); therefore, the high chair (100) is still perfectly stable.

In this way, the length of the base (A) can be minimized since at any height of the body, the projection (P) of the center of gravity (CM) passes through the midpoint (M) of the base (A).

In addition, by tilting the seat (401) with respect to a horizontal plane and the backrest (402) with respect to a vertical plane, the center of gravity (CM) is moved forward or backward. However, since the projection (P) of the center of gravity (CM) lies on the midpoint of the base, the projection (P) of the center of gravity (CM) will move forward or backward with respect to the midpoint and thus will always be contained in the base, even with a limited length of the base. Thus, the lifting system (C) according to the invention provides a wide tilting range of the seat and of the backrest, without having to increase the size of the base.

1. A high chair comprising a base, a body comprising a seat and a lifting system arranged between the base and the body to lift the body relative to the base in an adjustable manner, ; wherein the lifting system comprises:
a first lower lever and a second lower lever pivoted to the base;
a first upper lever and a second upper lever pivoted to the body;
a first connecting rod pivoted to the first lower lever to the second lower lever to the first upper lever and to the second upper lever;
a second connecting rod pivoted to the first lower lever and to the first upper lever;
a first actuator pivoted to the base and to the second lower lever for moving the assembly comprising the first lower lever and the second lower lever relative to the base; and
a second actuator pivoted to the body and to the second lower lever for allowing a compass-like movement of the assembly comprising the first upper lever and the second upper lever relative to the assembly comprising the first lower lever and the second lower lever.

2. The high chair of claim 1, wherein:
the first lower lever and the second lower lever are substantially parallel to each other;
the first upper lever and the second upper lever are substantially parallel to each other; and
the first connecting rod and the second connecting rod are substantially parallel to each other in a substantially vertical direction.

3. The high chair of claim 1, wherein the second connecting rod is a straight rod and the first connecting rod is configured like a broken line with square wave shape.

4. The high chair of claim 3, wherein, starting from a lower end the first connecting rod comprises a first vertical section which continues with a first horizontal section which continues with a second vertical section which continues with a second horizontal section terminating in an upper end

5. The high chair of claim 1, wherein the first actuator and the second actuator are linear actuators comprising a piston sliding in a cylinder.

6. The high chair of claim 1, comprising actuating means connected to the first actuator and to the second actuator for actuating said actuators.

7. The high chair of claim 6, wherein said actuating means comprise a pedal disposed in a rear part of the base and connections connecting the pedal to the actuators.

8. The high chair of claim 6, wherein the actuators are of pneumatic type and comprise normally closed valves that lock the actuators in position and the actuating means are configured to open the valves of the actuators when they are actuated.

9. The high chair of claim 1, comprising:
a lower tube corresponding to the second lower lever and containing the first lower lever; and
an upper tube corresponding to the second upper lever and containing the first upper lever.

10. The high chair of claim 1, comprising two lifting systems mounted on the sides of the high chair; the two lifting systems being connected to each other by a first crosspiece and a second crosspiece wherein the first crosspiece connects the two first tubes and the second crosspiece connects the two second tubes.

11. The high chair of claim 1, wherein the body comprises a frame comprising:
a first portion connected to the lifting means;
a second portion that supports a seat and is pivoted to the first portion by means of a first hinge; and
a third portion that supports a backrest and is pivoted to the second portion by means of a second hinge
said high chair also comprising:
first adjustment means interposed between the first portion of the frame and the second portion of the frame to adjust an inclination of the seat relative to a horizontal plane; and
second adjustment means interposed between the second portion of the frame and the third portion of the frame to adjust an inclination of the backrest relative to the seat.
